(19) United States
(12) Patent Application Publication
(10) Pub. No.: US 2010/0242046 A1
(43) Pub. Date: Sep. 23, 2010

(54) MULTICORE PROCESSOR SYSTEM, SCHEDULING METHOD, AND COMPUTER PROGRAM PRODUCT

(75) Inventor: Tatsuya MORI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/606,565

(22) Filed: Oct. 27, 2009

(30) Foreign Application Priority Data
Mar. 18, 2009 (JP) 2009-066916

(51) Int. Cl. G06F 9/50

(52) U.S. Cl. 718/104

(57) ABSTRACT

A multicore processor system includes: a plurality of software units, each of which executes predetermined processing using one or more cores among a plurality of cores of a multicore processor; and a scheduler that performs adjustment of allocation of the cores of the multicore processor to each of the software units and core occupation time of each of the software units to cause the software units to operate in parallel. Each of the software units outputs execution result data of the predetermined processing to an output buffer and issues notification based on an accumulated amount of the execution result data, which is output to the output buffer by the software unit, to the scheduler. The scheduler adjusts, based on the received notification, any one of a number of cores allocated to each of the software units and core occupation time of each of the software units or both.

### CROSS-REFERENCE TO RELATED APPLICATIONS

This application is based upon and claims the benefit of priority from the prior Japanese Patent Application No. 2009-066916, filed on Mar. 18, 2009; the entire contents of which are incorporated herein by reference.

### BACKGROUND OF THE INVENTION

1. Field of the Invention

The present invention relates to a multicore processor system, a scheduling method, and a computer program product.

2. Description of the Related Art

In recent years, a semiconductor integrated circuit device (a multicore processor system) mounted with a multicore processor is often mounted on apparatuses required to have various and a large number of advanced functions such as an audio visual apparatus to realize the large number of functions. In the multicore processor system mounted on such apparatuses, several kinds of firmware (FW) as computer programs for realizing the respective unit functions are caused to operate in parallel. When FW with high required performance is caused to operate, it is necessary to simultaneously allocate a plurality of cores to this FW.

In a semiconductor microprocessing process in these days, power consumption due to a leak current is conspicuously large. To reduce the power consumption due to the leak current in the multicore processor, it is effective to physically turn off a power supply to unnecessary cores. However, in the past, in general, the multicore processor system statically estimates performances required for the respective kinds of FW and schedules distribution of core resources for each of the kinds of FW according to a worst case. In this system, redundant core resources are distributed to the respective kinds of FW in most cases. A gross amount of core resources, in particular, spatial core resources allocated the FW, i.e., the number of cores allocated to the FW tends to be large. In other words, the number of unnecessary cores, for which a power supply can be turned off, decreases.

As a publicly-known technology concerning a core resource allocation method in the multicore processor, for example, there are technologies disclosed in Japanese Patent Application Laid-Open No. 2006-24180 and Japanese Translation of International Application No. 2007-531137. However, both the technologies do not assume allocation of a plurality of cores to one kind of FW. Therefore, the problem cannot be solved.

### BRIEF SUMMARY OF THE INVENTION

A multicore processor system according to an embodiment of the present invention comprises: a multicore processor; a plurality of software units, each of which executes predetermined processing using one or more cores among a plurality of cores of the multicore processor; and a scheduler that performs adjustment of allocation of the cores of the multicore processor to each of the software units and core occupation time of each of the software units to cause the software units to operate in parallel, wherein each of the software units outputs execution result data of the predetermined processing to an output buffer and issues notification based on an accumulated amount of the execution result data, which is output to the output buffer by the software unit, to the scheduler, and the scheduler adjusts, based on the received notification, any one of a number of cores allocated to each of the software units and core occupation time of each of the software units or both.

A scheduling method according to an embodiment of the present invention for applying adjustment of allocation of cores of a multicore processor and core occupation time to a plurality of software units and causing the software units to operate in parallel, each of the software units executing predetermined processing using one or more cores among a plurality of cores of the multicore processor and outputting execution result data of the predetermined processing to an output buffer comprises: adjusting, when each of the software units issues notification based on an accumulated amount of the execution result data output to the output buffer by the software unit, based on the issued notification, any one of a number of cores allocated to each of the software units and core occupation time of the software unit or both.

A computer program product according to an embodiment of the present invention executable by a computer for applying adjustment of allocation of cores of a multicore processor and core occupation time to a plurality of software units and causing the software units to operate in parallel, each of the software units executing predetermined processing using one or more cores among a plurality of cores of the multicore processor and outputting execution result data of the predetermined processing to an output buffer, causes the computer to adjust, when each of the software units issues notification based on an accumulated amount of the execution result data output to the output buffer by the software unit, based on the issued notification, any one of a number of cores allocated to each of the software units and core occupation time of the software unit or both.

### BRIEF DESCRIPTION OF THE DRAWINGS

FIG. 1 is a block diagram of a configuration of a multicore processor system according to an embodiment of the present invention;

FIG. 2 is a diagram for conceptually explaining positioning of computer programs and a multicore processor;

FIG. 3 is a diagram for explaining a functional configuration;

FIG. 4 is a flowchart for explaining the operation of FW;

FIG. 5A is a flowchart for explaining the operation of a scheduler;

FIG. 5B is a flowchart for explaining the operation of a scheduler; and

FIG. 6 is a diagram for explaining a specific example of scheduling.

### DETAILED DESCRIPTION OF THE INVENTION

Exemplary embodiments of a multicore processor system, a scheduling method, and a computer program product according to the present invention will be explained below in detail with reference to the accompanying drawings. The present invention is not limited to the following embodiments.

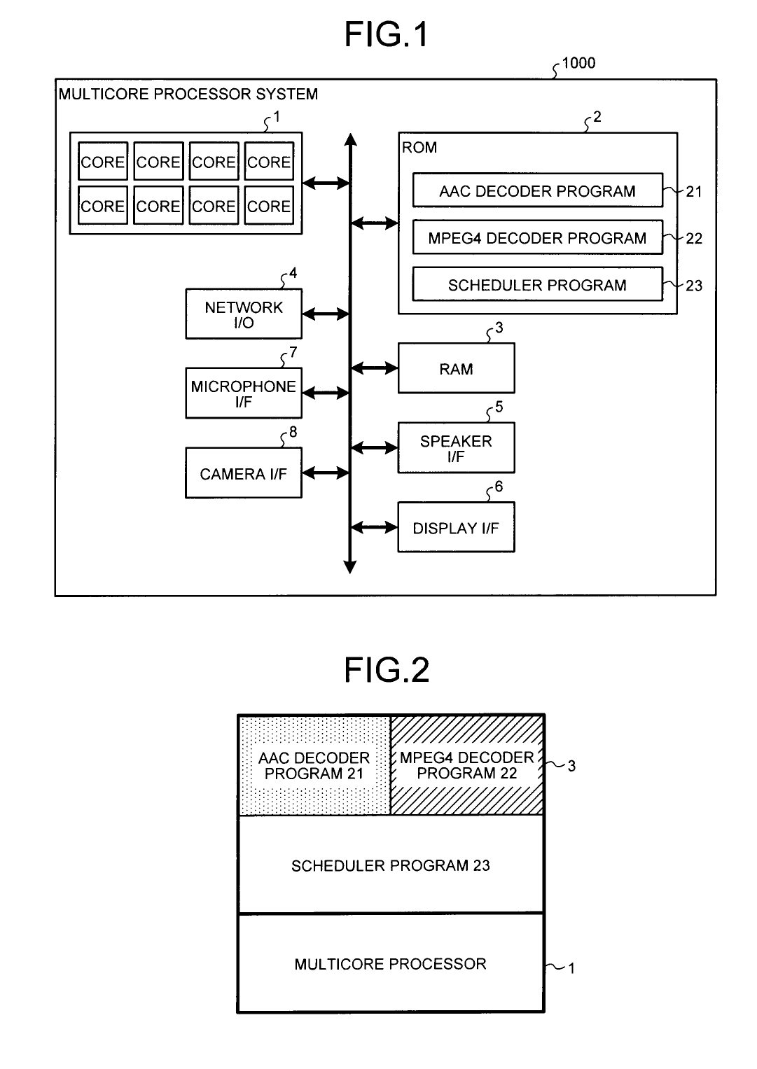

FIG. 1 is a block diagram of a configuration of a multicore processor system according to an embodiment of the present invention. In the following explanation, the embodiment is applied to a multicore processor system for multimedia processing that executes various kinds of processing for multimedia information such as audio data and image data. However, an application range of the embodiment is not limited to the multicore processor system for multimedia processing.

As shown in FIG. 1, a multicore processor system 1000 includes a multicore processor 1 having a plurality of (eight) cores, a read only memory (ROM) 2, a random access memory (RAM) 3, a network input/output (I/O) 4 as an I/O for receiving the input of videos and sound distributed via a network and transmitting information to a distribution source, a speaker interface (I/F) 5 as an interface with a speaker for outputting audio data, a display I/F 6 as an I/F for outputting video data to a display, a microphone I/F 7 for receiving the input of audio data from a microphone, and a camera I/F 8 for receiving the input of video data from a camera.

The ROM 2 has stored therein a plurality of kinds of firmware (FW) as computer programs for controlling the units of the multicore processor system 1000 and causing apparatuses mounted with the multicore processor system 1000 to realize respective functions and a scheduler program 23 as a computer program for applying scheduling of a plurality of cores of the multicore processor 1, i.e., allocation of core resources to the respective kinds of FW. For simplification of explanation, it is assumed that an AAC decoder program 21 and a MPEG4 decoder program 22 for respectively restoring audio data compressed in the AAC standard and video data compressed in the MPEG4 standard, which are input from the network I/O 4, are stored as the FW stored in the ROM 2. The scheduler program 23, the AAC decoder program 21, and the MPEG4 decoder program 22 stored in the ROM 2 are read out and expanded on the RAM 3 by the multicore processor 1.

FIG. 2 is a diagram for conceptually explaining positioning of the MPEG4 decoder program 22, the ACC decoder program 21, and the scheduler program 23 as software units expanded on the RAM 3, and the multicore processor 1. As shown in the figure, the scheduler program 23 is present to be interposed between the MPEG4 decoder program 22 and ACC decoder program 21 and the multicore processor 1. More specifically, temporal and spatial core resources of the processor core 1 are respectively allocated to the MPEG4 decoder program 22 and the ACC decoder program 21 expanded on the RAM 3 according to scheduling control realized by the cooperation of the scheduler program 23 expanded on the RAM 3 and the multicore processor 1. The decoder program 21 and 22 execute restoration processing for data using the core resources allocated by the scheduler program 23. “Temporal core resources are allocated” means that core occupation time is allocated. “Spatial core resources are allocated” means that one or more cores in use among seven cores are allocated. The remaining one core among the eight cores is allocated to the scheduler program 23. The seven cores are allocated to the respective decoder programs. A scheduling control function realized by the cooperation of the scheduler program 23 expanded on the RAM 3 and the multicore processor 1 is simply referred to as scheduler 23 below.

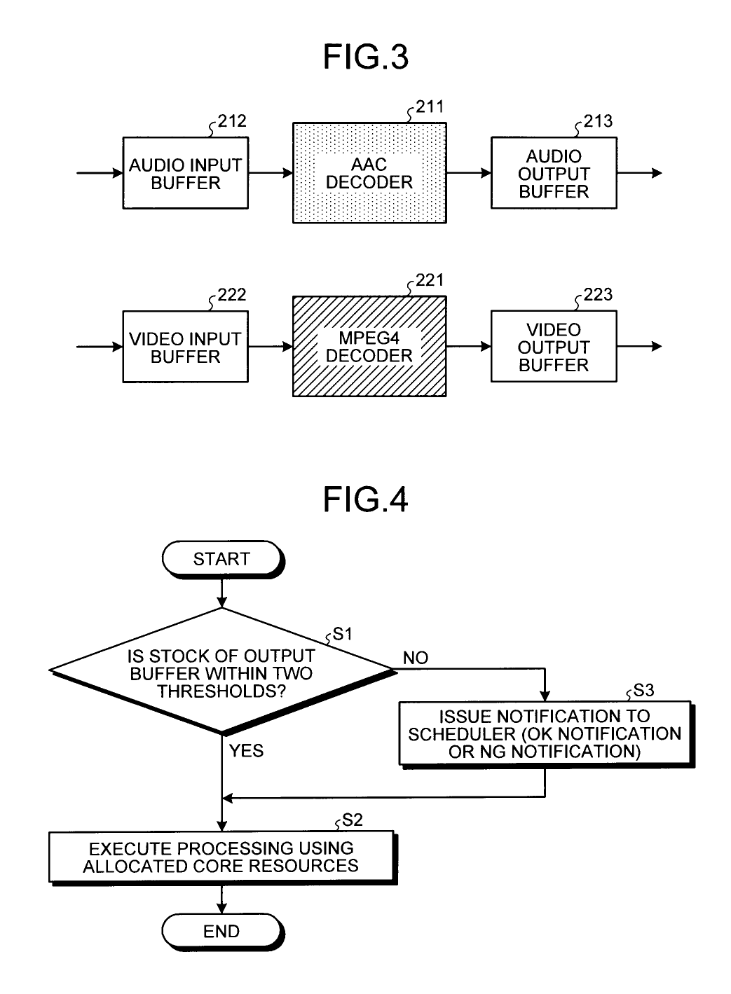

FIG. 3 is a diagram for explaining a functional configuration realized by using the core resources of the multicore processor 1 respectively allocated to the decoder programs expanded on the RAM 3. As shown in the figure, the AAC decoder program 21 realizes an audio input buffer 212, an AAC decoder 211, and an audio output buffer 213. The MPEG4 decoder program 22 realizes a video input buffer 222, a MPEG4 decoder 221, and a video output buffer 223. The audio input buffer 212, the audio output buffer 213, the video input buffer 222, and the video output buffer 223 are specifically storage areas secured on the RAM 3. The audio input buffer 212 temporarily stores compressed audio data input from the network I/O 4. The AAC decoder 211 sequentially extracts the compressed audio data stored in the audio input buffer 212, sequentially executes restoration processing on the extracted compressed audio data, and outputs an execution result to the audio output buffer 213. The restored audio data output to the audio output buffer 213 is output to the speaker via the speaker I/F 5. The video input buffer 222 temporarily stores compressed video data input from the network I/O 4. The MPEG4 decoder 221 sequentially extracts the compressed video data stored in the video input buffer 222, sequentially executes restoration processing on the extracted compressed video data, and outputs an execution result to the video output buffer 223. The restored video data output to the video output buffer 223 is output to the display via the display I/F 6. The AAC decoder program 21 and the MPEG4 decoder program 22 expanded on the RAM 3 can also be respectively grasped as software units. The AAC decoder 211 and the MPEG4 decoder 221 can also be respectively grasped as software units.

The output buffers 213 and 223 store the restored data in frame units. The output buffers 213 and 223 have limits in storage capacities. The AAC decoder 211 and the MPEG4 decoder 221 respectively have functions of determining, according to the numbers of frames stored in the output buffers 213 and 223, i.e., accumulated amounts of processing result data output by the AAC decoder 211 and the MPEG4 decoder 221, whether the AAC decoder 211 and the MPEG4 decoder 221 are operating in a range of required performance and notifying the scheduler 23 of a determination result. For example, it is assumed that an upper limit of the storage capacities of the output buffers 213 and 223 is twenty frames. When the numbers of frames stored in the output buffers 213 and 223 are equal to or larger than 15, the AAC decoder 211 and the MPEG4 decoder 221 issue OK notification indicating that the required performance is sufficiently satisfied. When the numbers of frames stored in the output buffers 213 and 223 are equal to or smaller than 5, the AAC decoder 211 and the MPEG4 decoder 221 issue NG notification indicating that the required performance is not satisfied. An upper limit of the range of the required performance is referred to as upper limit threshold (second threshold) and a lower limit thereof is referred to as lower limit threshold (first threshold).

When the scheduler 23 receives, from the FW (the AAC decoder 211 or the MPEG4 decoder 221), notification to the effect that the required performance is not satisfied, the scheduler 23 increases any one of temporal core resources and spatial core resources or both allocated to the FW at the notification transmission source. When the scheduler 23 receives, from the FW, notification to the effect that the required performance is sufficiently satisfied, the scheduler 23 reduces any one of temporal core resources and spatial core resources or both allocated to the FW at the notification transmission source.

A scheduling method executed by the multicore processor system 1000 according to this embodiment is explained. FIG. 4 is a flowchart for explaining the operation of the FW 211 and the FW 221. Because the AAC decoder 211 and the MPEG4 decoder 221 execute the same operation, only the operation of the AAC decoder 211 is explained as a representative.

As shown in FIG. 4, the AAC decoder 211 determines whether an amount of restored audio data (stock) stored in the audio output buffer 213 is between the upper limit threshold and the lower limit threshold set in advance (step S1). When the amount of the restored data is within a range of the two thresholds (“Yes” at step S1), the AAC decoder 211 is allocated with temporal and spatial core resources by the scheduler 23, acquires compressed audio data stored in the audio input buffer 212 using the allocated temporal and spatial core resources, and executes restoration processing on the acquired audio data (step S2).

On the other hand, when the amount of the restored audio data stored in the audio output buffer 213 is not within the range of the two thresholds (“No” at step S1), the AAC decoder 211 issues notification to the scheduler 23 (step S3). Specifically, as explained above, the AAC decoder 211 issues OK notification when an accumulated amount of the audio output buffer 213 exceeds the upper limit threshold and issues NG notification when the accumulated amount of the audio output buffer 213 is smaller than the lower limit threshold. The AAC decoder 211 shifts to step S2.

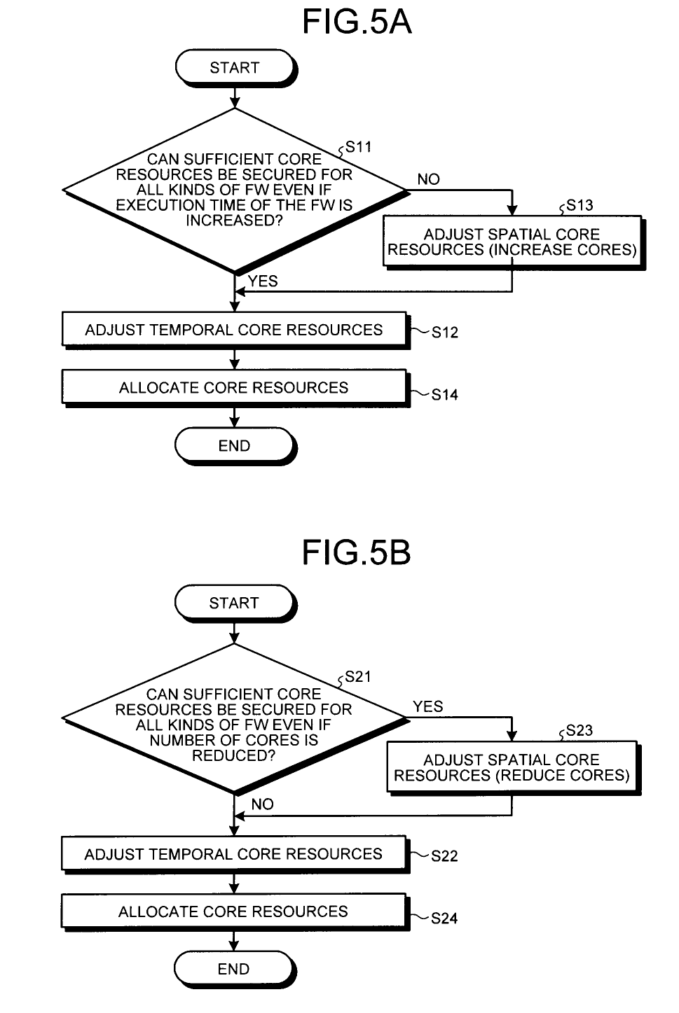

FIGS. 5A and 5B are flowcharts for explaining the operation of the scheduler 23 for changing, based on notification from the FW 211 and the FW 221, allocation of core resources. As shown in FIG. 5A, the scheduler 23 that receives the NG notification determines whether sufficient temporal and spatial core resources can be secured for all the kinds of FW, i.e., the FW 211 and the FW 221, even if execution time of the FW at the NG notification source is increased (step S11). When the sufficient temporal and spatial core resources can be secured (“Yes” at step S11), the scheduler 23 adjusts temporal core resources of the FW 211 and the FW 221 (step S12). Specifically, the scheduler 23 increases execution time of the FW at the NG notification source and reduces execution time of the other FW by an amount of increase in the execution time. When temporal and spatial core resources of the FW 211 and the FW 221 cannot be secured if the execution time of the FW at the NG notification source is increased (“No” at step S11), the scheduler 23 adjusts the spatial core resources of the FW 211 and the FW 221 (step S13). Specifically, the scheduler 23 increases the number of cores allocated to the FW at the NG notification source and adjusts the number of cores allocated to the other FW according to the increase of the number of cores allocated to the FW at the NG notification source (step S13). The scheduler 23 adjusts the temporal core resources of the FW 211 and the FW 221 (step S12). After step S12, the scheduler 23 allocates the temporal and spatial core resources after the adjustment to the FW 211 and the FW 221 (step S14).

As shown in FIG. 5B, the scheduler 23 that receives the OK notification determines whether sufficient temporal and spatial core resources can be secured for the FW 211 and the FW 221 even if the number of cores allocated to the FW at the OK notification source is reduced (step S21). When the sufficient temporal and spatial core resources cannot be secured for the FW 211 and the FW 221 (“No” at step S21), the scheduler 23 adjusts the temporal core resources of the FW 211 and the FW 221 (step S22). Specifically, the scheduler 23 reduces execution time of the FW at the OK notification source and allocates a reduced amount of the execution time to the other FW. When the sufficient temporal and spatial core resources can be secured for the FW 211 and the FW 221 even if the number of cores of the FW at the OK notification source is reduced (“Yes” at step S21), the scheduler 23 adjusts the spatial core resources of the FW 211 and the FW 221 (step S23). Specifically, the scheduler 23 reduces the number of cores allocated the FW at the OK notification source and adjusts the number of cores allocated to the other FW. The scheduler 23 adjusts execution time allocated to the FW 211 and the FW 221 (step S22). After step S22, the scheduler 23 allocates the temporal and spatial core resources after the adjustment to the FW 211 and the FW 221 (step S24).

In this way, when the scheduler 23 receives the NG notification, the scheduler 23 more preferentially increases the core occupation time than the number of allocated cores. When the scheduler 23 receives the OK notification, the scheduler 23 more preferentially reduces the number of allocated cores than the core occupation time. Specifically, the scheduler 23 performs scheduling to reduce a total of the numbers of allocated cores as much as possible.

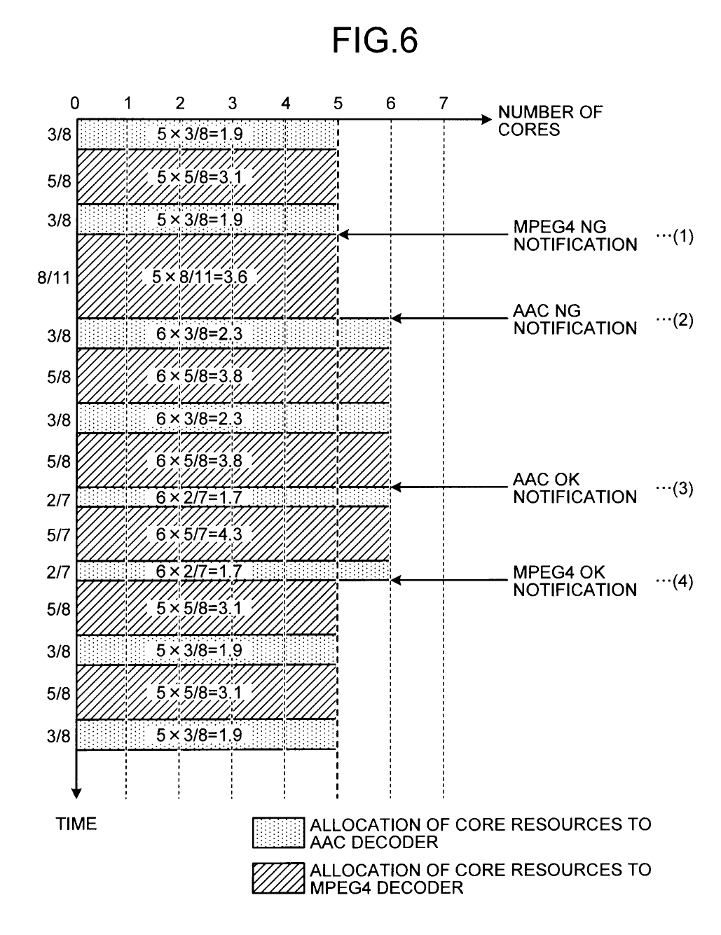

A specific example of the scheduling performed for the MPEG4 decoder 221 and the AAC decoder 211 by the method explained above is explained with reference to FIG. 6.

In FIG. 6, the abscissa represents an allocation state of the seven processor cores and the ordinate represents a time axis that advances downward on the figure. In default setting, as temporal core resources, ⅜ of unit time is allocated to the AAC decoder 211 and the remaining ⅝ time is allocated to the MPEG4 decoder 221. Five cores are allocated to each of the AAC decoder 211 and the MPEG4 decoder 221 as spatial core resources. Values obtained by multiplying together the temporal core resources and the spatial core resources are referred to as integrated core resources. At steps S11 and S21, the scheduler 23 determines, based on the integrated core resources, whether sufficient temporal and spatial core resources are secured in both the FW 211 and the FW 221.

In FIG. 6, in blocks at upper three stages, i.e., execution processing of the AAC decoder 211 for the first time, execution processing of the MPEG4 decoder 221 for the first time, and execution processing of the AAC decoder 211 for the second time, it is determined in step S1 that the amount of the restored data is within the range of the two thresholds. The temporal and spatial core resources of the default setting are allocated to the AAC decoder 211 and the MPEG4 decoder 221 and the respective kinds of processing are executed.

In execution processing of the MPEG4 decoder 221 for the second time, an accumulated amount of video data stored in the video output buffer 223 is smaller than the lower limit threshold. The MPEG4 decoder 221 issues NG notification ((1) in the figure). Then, the scheduler 23 adjusts the temporal core resources and changes execution times allocated to the AAC decoder 211 and the MPEG4 decoder 221 to 3/11 and 8/11 of the unit time, respectively. Specifically, the integrated core resource of the AAC decoder 211 changes from 5×3/8=1.9 to 5×3/11=1.4 and the integrated core resource of the MPEG4 decoder 221 changes from 5×5/8=3.1 to 5×8/1=3.6.

In execution processing of the AAC decoder 211 for the third time, an accumulated amount of audio data stored in the audio output buffer 213 is smaller than the lower limit threshold. The AAC decoder 211 issues NG notification ((2) in the figure). Then, the scheduler 23 evaluates the respective integrated core resources and recognizes that the required performance of the MPEG4 decoder 221 cannot be satisfied if the temporal core resources are adjusted, i.e., the execution time allocated to the AAC decoder 211 is increased and the execution time allocated to the MPEG4 decoder is reduced. Therefore, the scheduler 23 adjusts the spatial core resources and the temporal core resources. Specifically, the scheduler 23 increases the number of cores allocated to each of the AAC decoder 211 and the MPEG4 decoder 221 from five to six. 3/11 and 8/11 of the unit time respectively allocated as the execution times are reset to ⅜ and ⅝ of the default setting. Then, the integrated core resources allocated to the AAC decoder 211 and the MPEG4 decoder 221 respectively change from 1.9 and 3.6 to 2.3 and 3.8.

In execution processing of the AAC decoder 211 for the fifth time, an accumulated amount of audio data stored in the audio output buffer 213 is larger than the upper limit threshold. The AAC decoder 211 issues OK notification ((3) in the figure). Then, the scheduler 23 evaluates the respective integrated core resources and recognizes that the required performance of the MPEG4 decoder 221 cannot be satisfied if the spatial resources are reduced. Therefore, the scheduler 23 executes only adjustment of the temporal core resources. Specifically, the scheduler 23 reduces the execution time allocated to the AAC decoder 211 and increases the execution time allocated to the MPEG4 decoder 221. The scheduler 23 changes the execution times allocated to the ACC decoder 211 and the MPEG4 decoder 221 to 2/7 and 5/7, respectively. Then, the integrated core resources allocated to the ACC decoder 211 and the MPEG4 decoder 221 respectively change from 2.3 and 3.8 to 1.7 and 4.3.

In execution processing of the MPEG4 decoder 221 for the sixth time, an accumulated amount of video data stored in the video output buffer 223 is larger than the upper limit threshold. The MPEG4 decoder 221 issues OK notification ((4) in the figure). Then, the scheduler 23 evaluates the respective integrated core resources, determines that the spatial resources can be reduced, and executes adjustment of the spatial and temporal core resources. Specifically, the scheduler 23 reduces the number of cores from six to five and resets the respective execution times to the default set values. Then, the integrated core resources allocated to the AAC decoder 211 and the MPEG4 decoder 221 respectively change from 1.7 and 4.3 to 1.9 and 3.1.

As explained above, according to this embodiment, the FW 211 and the FW 221 respectively output the restored data to the output buffers 213 and 223 and issue notification based on an accumulated amount of the restored data, which is output to the output buffers 213 and 223 by the FW 211 and the FW 221, to the scheduler 23. When the scheduler 23 receives the notification, the scheduler 23 increases or reduces, based on the received notification, the number of cores allocated to the FW 211 and the FW 221 and the core occupation time of the FW 211 and the FW 221. Therefore, flexible scheduling can be executed according to the required performance of the FW 211 and the FW 221 that fluidly changes after the start of execution of the restoration processing. This makes it possible to reduce the number of allocated cores as much as possible while satisfying the required performance. When the number of allocated cores is reduced, because a power supply to unnecessary cores can be turned off, reduction in power consumption on a best-effort basis is realized.

In the explanation with reference to FIG. 6, the MPEG4 decoder 221 and the AAC decoder 211 operate in parallel in a time division manner. However, the same effects can be obtained when the two kinds of FW operate in parallel in a space division manner rather than in a time division manner. The same holds true when the two kinds of FW operate in parallel in a time division manner and a space division manner.

In the above explanation, one core is allocated to the scheduler program and the remaining seven cores are respectively allocated to the decoder programs. However, all the eight cores can be allocated to the scheduler program and the two decoder programs. In other words, the scheduler program applies core resource allocation not only to the two decoder program but also to the scheduler program itself.

In the above explanation, the scheduler is realized by the cooperation of the scheduler program 23 expanded on the RAM 3 and the multicore processor 1. However, hardware dedicated to scheduling may be provided in the multicore processor system 1000 and execute core resource allocation to the two decoder programs.

In the above explanation, the audio input buffer 212, the audio output buffer 213, the video input buffer 222, and the video output buffer 223 are specifically the memory areas secured on the RAM 3. However, places of the respective buffers 212, 213, 222, and 223 do not have to be located on the RAM 3.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A multicore processor system comprising:
a multicore processor;
a plurality of software units, each of which executes predetermined processing using one or more cores among a plurality of cores of the multicore processor; and
a scheduler that performs adjustment of allocation of the cores of the multicore processor to each of the software units and core occupation time of each of the software units to cause the software units to operate in parallel, wherein
each of the software units outputs execution result data of the predetermined processing to an output buffer and issues notification based on an accumulated amount of the execution result data, which is output to the output buffer by the software unit, to the scheduler, and
the scheduler adjusts, based on the received notification, any one of a number of cores allocated to each of the software units and core occupation time of each of the software units or both.

2. The multicore processor system according to claim 1, wherein
the notification issued by each of the software units includes first notification issued when the accumulated amount of the data output to the output buffer by the software unit is smaller than a first threshold and second notification issued when the accumulated amount of the data output to the output buffer by the software unit is larger than a second threshold, and
the scheduler increases, when the first notification is received, at least one of a number of cores allocated to the issue source of the first notification and core occupation time of the issue source and reduces, when the second notification is received, at least one of a number of cores allocated to the issue source of the second notification and core occupation time of the issue source.

3. The multicore processor system according to claim 2, wherein the scheduler more preferentially increases, in increasing or reducing the number of cores allocated to the issue source of the first notification and the core occupation time of the issue source of the first notification, the core occupation time than the number of allocated cores and more preferentially reduces, in increasing or reducing the number of cores allocated to the issue source of the second notification and the core occupation time of the issue source of the second notification, the number of allocated cores than the core occupation time.

4. The multicore processor system according to claim 2, wherein the scheduler determines, when the first notification is received, based on a number of allocated cores and core occupation time secured for the software unit that operates in parallel with the issue source of the first notification, whether the number of cores allocated to the issue source of the first notification should be increased and determines, when the second notification is received, based on a number of allocated cores and core occupation time secured for the software unit that operates in parallel with the issue source of the second notification, whether the number of cores allocated to the issue source of the second notification should be reduced.

5. A scheduling method for applying adjustment of allocation of cores of a multicore processor and core occupation time to a plurality of software units and causing the software units to operate in parallel, each of the software units executing predetermined processing using one or more cores among a plurality of cores of the multicore processor and outputting execution result data of the predetermined processing to an output buffer,
the scheduling method comprising adjusting, when each of the software units issues notification based on an accumulated amount of the execution result data output to the output buffer by the software unit, based on the issued notification, any one of a number of cores allocated to each of the software units and core occupation time of the software unit or both.

6. The scheduling method according to claim 5, wherein
the notification issued by each of the software units includes first notification issued when the accumulated amount of the data output to the output buffer by the software unit is smaller than a first threshold and second notification issued when the accumulated amount of the data output to the output buffer by the software unit is larger than a second threshold, and
the adjusting includes:
increasing, when the software unit issues the first notification, at least one of a number of cores allocated to the issue source of the first notification and core occupation time of the issue source; and
reducing, when the software unit issues the second notification, at least one of a number of cores allocated to the issue source of the second notification and core occupation time of the issue source.

7. The scheduling method according to claim 6, wherein
the increasing includes more preferentially increasing the core occupation time than the number of allocated cores, and
the reducing includes more preferentially reducing the number of allocated cores than the core occupation time.

8. The scheduling method according to claim 6, wherein
the increasing includes determining, based on a number of allocated cores and core occupation time secured for the software unit that operates in parallel with the issue source of the first notification, whether the number of cores allocated to the issue source of the first notification should be increased, and
the reducing includes determining, based on a number of allocated cores and core occupation time secured for the software unit that operates in parallel with the issue source of the second notification, whether the number of cores allocated to the issue source of the second notification should be reduced.

9. A computer program product executable by a computer for applying adjustment of allocation of cores of a multicore processor and core occupation time to a plurality of software units and causing the software units to operate in parallel, each of the software units executing predetermined processing using one or more cores among a plurality of cores of the multicore processor and outputting execution result data of the predetermined processing to an output buffer,
the computer program product causing the computer to adjust, when each of the software units issues notification based on an accumulated amount of the execution result data output to the output buffer by the software unit, based on the issued notification, any one of a number of cores allocated to each of the software units and core occupation time of the software unit or both.

10. The computer program product according to claim 9, wherein
the notification issued by each of the software units includes first notification issued when the accumulated amount of the data output to the output buffer by the software unit is smaller than a first threshold and second notification issued when the accumulated amount of the data output to the output buffer by the software unit is larger than a second threshold, and
the adjusting includes:
increasing, when the software unit issues the first notification, at least one of a number of cores allocated to the issue source of the first notification and core occupation time of the issue source; and
reducing, when the software unit issues the second notification, at least one of a number of cores allocated to the issue source of the second notification and core occupation time of the issue source.

11. The computer program product according to claim 10, wherein
the increasing includes more preferentially increasing the core occupation time than the number of allocated cores, and
the reducing includes more preferentially reducing the number of allocated cores than the core occupation time.

12. The computer program product according to claim 10, wherein
the increasing includes determining, based on a number of allocated cores and core occupation time secured for the software unit that operates in parallel with the issue source of the first notification, whether the number of cores allocated to the issue source of the first notification should be increased, and
the reducing includes determining, based on a number of allocated cores and core occupation time secured for the software unit that operates in parallel with the issue source of the second notification, whether the number of cores allocated to the issue source of the second notification should be reduced.
